(19) United States
(12) Patent Application Publication
(10) Pub. No.: US 2011/0056443 A1
(43) Pub. Date: Mar. 10, 2011

(54) Back-carried work apparatus

(75) Inventor: Harald Schliemann, Waiblingen (DE)

(73) Assignee: Andreas Stihl AG & Co. KG.

(21) Appl. No.: 12/805,898

(22) Filed: Aug. 24, 2010

(30) Foreign Application Priority Data
Sep. 8, 2009 (DE) 10 2009 040 494.5

(51) Int. Cl. F02B 63/02

(52) U.S. Cl. 123/2

(57) ABSTRACT

A back-carried work apparatus has a back carrier (2), which has two shoulder straps (3, 4) to carry the back carrier (2) on a back and carries a drive motor (20). The drive motor (20) is configured as a combustion engine. A fuel tank (7) for the drive motor (20) is arranged on the back carrier (2). In order to make fuel extraction possible up to the least possible amount of residual, the tank base (8, 28) of the fuel tank (7) has a lowest region which extends over less than 20% of the width (d) of the tank base (8, 28) when the shoulder straps (3, 4) are arranged on the shoulders of the operator.

### CROSS REFERENCE TO RELATED APPLICATION

This application claims priority of German patent application no. 10 2009 040 494.5, filed Sep. 8, 2009, the entire content of which is incorporated herein by reference.

### FIELD OF THE INVENTION

The invention relates to a back-carried work apparatus.

### BACKGROUND OF THE INVENTION

Back-carried work apparatuses typically have an elongated tank extending over the entire width of the work apparatus. A suction head is typically provided to draw fuel. For the suction head to be able to deliver fuel, a minimum fill level of the fuel is needed in the area of the suction head. Because the base of the tank is typically essentially even, a comparatively large residual amount of fuel cannot be drawn even on work apparatuses which are carried horizontally. The amount of fuel which cannot be extracted can become noticeably larger when the back carrier is not carried horizontally, for example, when the operator only has one shoulder strap on one shoulder, so that the entire back carrier is slanted. When the suction head is in a disadvantageous position a comparatively large amount of fuel cannot be extracted. As a result, frequent filling of the fuel tank is necessary, which considerably reduces the effective working time.

### SUMMARY OF THE INVENTION

It is an object of the invention to provide a back-carried work apparatus, in which the drawing of fuel is possible up until only a small amount of residual remains and which has a simple configuration.

The back-carried work apparatus of the invention includes: a back carrier having two shoulder straps configured for carrying the back carrier on an operator's shoulders; a drive motor configured as a combustion engine arranged on the back carrier; a fuel tank for the combustion engine arranged on the back carrier, the fuel tank having a tank base; the tank base having a width (d) and being configured to have a lowest region when the shoulder straps are arranged on the operator's shoulders; and, the lowest region extending over less than about 20% of the width (d) of the tank base.

The lowest area, which is formed comparatively narrowly, leads to a higher fill level with the same amount of fuel when compared to a fuel tank with an even base, so that also residual amounts can be easily drawn. Therein, it is advantageous to arrange means for drawing fuel in the lowest area.

A simple configuration results when the tank base has a first section, which is inclined relative to the horizontal level when the shoulder straps are arranged on the shoulders of an operator. The first section of the tank base is inclined relative to the horizontal level by an angle between about 7° and about 30°. The angle is advantageously chosen in such a manner that the first section remains inclined toward the center or at maximum is horizontal when the operator carries the back carrier only with the shoulder strap across from first section and the back carrier is therefore slanted on the back of the operator. Since the first section does not noticeably slope down toward the outside it is ensured that even when the back carrier is carried slanted and the fill level of the fuel is low, fuel can still be extracted. The first section advantageously slopes down toward the center of the tank base. Advantageously, a second section of the tank base is inclined in the opposite direction of the first section. The second section of the tank base is thereby also advantageously inclined relative to the horizontal level at an angle between about 7° and about 30°. In particular, the inclination of the first section of the tank base corresponds to the inclination of the second section. The lowest area is advantageously arranged between the first section and the second section and in the center of the tank base in relation to the width of the tank.

Advantageously, a middle section is arranged between the first section and the second section, which extends over less than 30% of the width of the tank base and includes the lowest area. The tank base in the middle section can advantageously be rounded. Thereby edges, on which a suction head or similar device for extracting fuel can become stuck on, are avoided in the tank base. This results in an attractive appearance of the fuel tank. Advantageously, the tank base is mirror-symmetrical to a center plane extending in the upward direction of the back carrier. The center plane thereby extends approximately perpendicularly to the plane of the operator's back and approximately vertically when the back carrier is carried straight.

It can also be provided that the first section slopes down from one side wall of the fuel tank to the other and that the lowest area is arranged adjacent to the side wall to which the first section slopes down towards. The fuel tank is thereby configured asymmetrically and the lowest area is arranged on the side. Advantageously, the work apparatus has an operating handle to guide the work apparatus while in operation and the lowest area is arranged on the side of the fuel tank which faces the aforementioned handle. When the back-carried work apparatus is carried with only one shoulder strap, the shoulder strap on the side facing away from the handle is typically on the shoulder, so that the work apparatus slopes down toward the side facing the handle. As a result of the inclination of the base of the fuel tank toward this side and the advantageous arrangement of means to extract fuel in this lateral area it can be ensured that a comparatively large amount of fuel can always be extracted from the fuel tank and only a very small amount of residual remains in the tank when the work apparatus is carried straight as well as when the work apparatus is carried by the shoulder strap on the opposite side of the handle.

To achieve a high fill level with small amounts of fuel in the tank, the sloped sections of the tank base extend over more than 70% of the width of the tank base of the fuel tank. More than two sloped sections can also be provided therein.

Advantageously, the tank base is inclined in the direction of the center plane in at least one area. In that the tank base is inclined in the direction of the center plane, that is, in the direction of the depth of the fuel tank, the amount of fuel which cannot be extracted from the fuel tank can be further minimized.

The fuel tank can be largely emptied. Advantageously, the tank base is configured in a funnel-like manner. Thus, all base surfaces are inclined toward the lowest area.

Advantageously, the fuel tank has a transverse plane which divides the fuel tank in the middle into a section facing the operator and a section facing away from the operator. The transverse plane thus typically runs parallel to the back carrying plate of the back carrier. Advantageously, the lowest area is arranged in the section facing away from the operator. During typical operation, the back carrier tilts back away from the back of the operator and rests against the back of the operator in its lower area. In that the lowest area is arranged in the externally located area of the fuel tank facing away from the operator, which during typical operation tilts downward, a good fuel extraction can be achieved.

The proposed configuration is especially advantageous in elongated tanks. The fuel tank has an advantageous width, which is at least double the height measured in the upward direction and at least double the depth of the fuel tank which is measured perpendicularly to the width and to the height. The back carrier advantageously has a base plate which extends in the direction of the horizontal level when the shoulder straps are arranged on the shoulders of the operator. The base of the fuel tank is thereby inclined relative to the base plate.

### BRIEF DESCRIPTION OF THE DRAWINGS

The invention will now be described with reference to the drawings wherein:

FIG. 1 is a side view of an operator with a back-carried work apparatus;

FIG. 2 is a side view of the work apparatus in the direction of arrow II of FIG. 1;

FIG. 3 is a side view of the work apparatus according to FIG. 2, when the back carrier is carried by only one shoulder strap;

FIG. 4 is a side view of the work apparatus according to

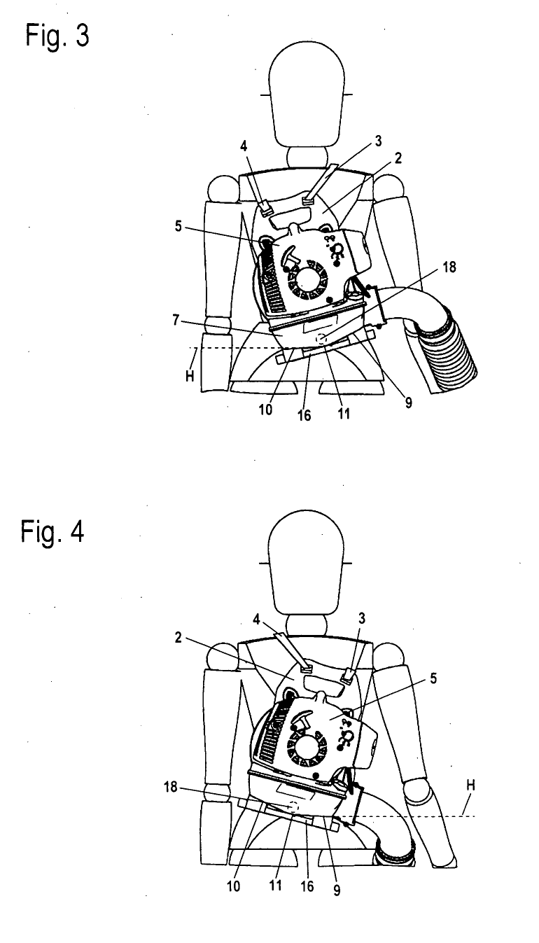

FIG. 2, when the back carrier is carried by only one shoulder strap;

FIG. 5 is a sectionally enlarged side view of the work apparatus in the area of the fuel tank;

FIG. 6 is a side view of the work apparatus;

FIG. 7 is a sectionally enlarged side view of an embodiment of the fuel tank.

### DESCRIPTION OF THE PREFERRED EMBODIMENTS OF THE INVENTION

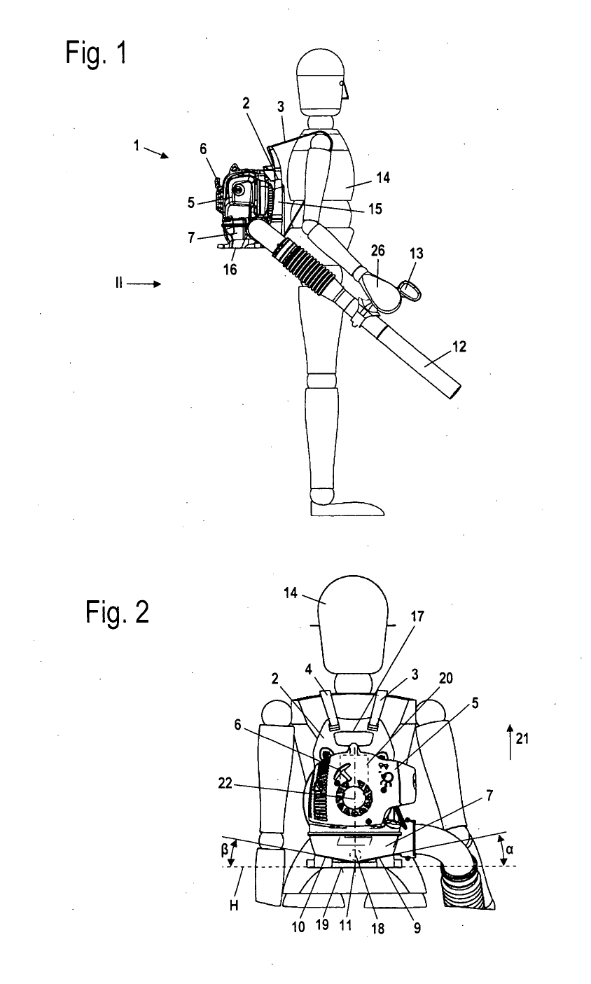

FIG. 1 shows as an example embodiment a blower 1 as a back-carried work apparatus. The blower 1 has a back carrier 2 which is carried on the back of an operator 14 with the shoulder straps 3 and 4 (FIG. 2). The back carrier 2 includes a back carrier plate 15, which advantageously rests on the back of the operator 14 and can be braced against the back via pads, as well as a base plate 16. A housing 5 of the blower 1 is held on the back carrier 2. The blower 1 has a fuel tank 7 which is arranged underneath the housing 5. The fuel tank 7 can, however, also be arranged in the housing 5 or be integrated into the housing 5. As FIG. 1 shows, a start handle 6 of a starting arrangement projects out of the housing 5. The blower 1 has a blower tube 12 on which an operating handle 13 is arranged. The operator 14 can hold and guide the blower tube 12 via the operating handle 13 with one hand 26, here with the right hand 26.

The start handle 6 serves to start a drive motor 20 arranged in the housing 5, which is shown schematically in FIG. 2. The drive motor 20 is configured as an internal combustion engine. During operation, the drive motor 20 draws in fuel from the fuel tank 7. When the operator 14 carries the back carrier 2 with both shoulder straps (3, 4), then the base 19 of the back carrier 2 is arranged horizontally and aligns with the horizontal line H. The tank 7 has a tank base 8 having a first inclined section 9 and a second inclined section 10. A middle section 11 is arranged between the two inclined sections 9 and 10.

The first section 9 is inclined relative to the horizontal line by an angle α, which advantageously is between about 7° and about 30°. An angle α between about 10° and about 20° has proven to be expedient. The angle α is chosen so that the tank base 8 slopes down in the first section 9 toward the middle section 11. The second section 10 is inclined relative to the horizontal line H by an angle β, which is between about 7° and about 30° and advantageously between about 10° and about 20°. Advantageously, the angles α and β are the same size and the tank base 8 is mirror-symmetrical to a center plane 22 running in the upward direction 21 of the blower 1 and about perpendicularly to the back carrier plate 15. The upward direction 21 is essentially vertical when both shoulder straps 3 and 4 are arranged on the shoulders of the operator 14.

In the area of the middle section 11, a suction head 18 is arranged in the interior of the fuel tank 7, via which fuel is taken from the fuel tank 7 and drawn to the drive motor 20. As also shown in FIG. 2, the back carrier plate 15 has a handle 17 with which the back carrier 2 can be carried by hand.

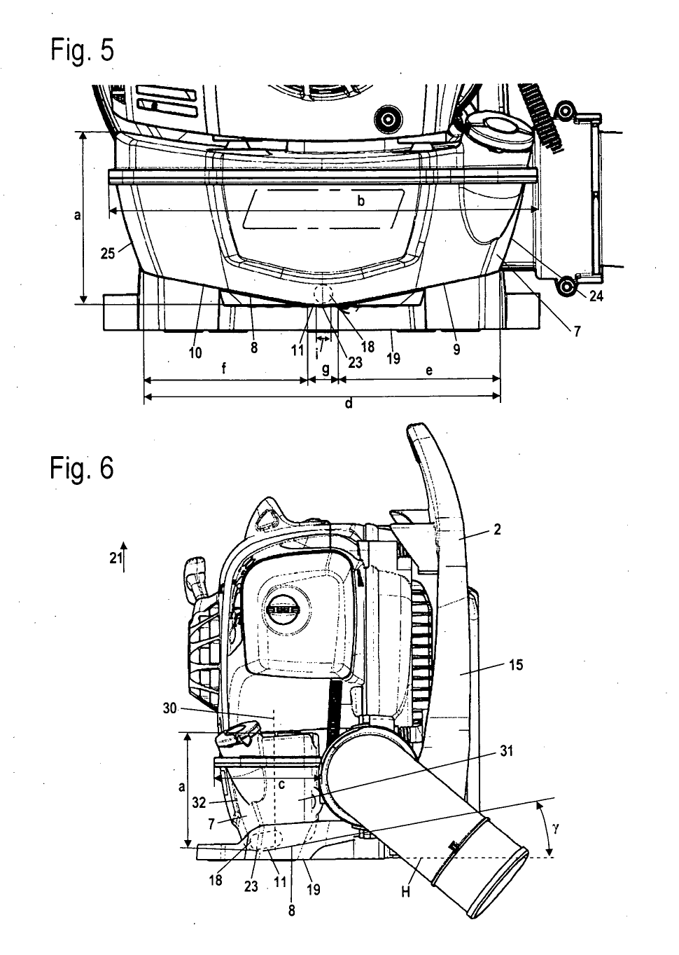

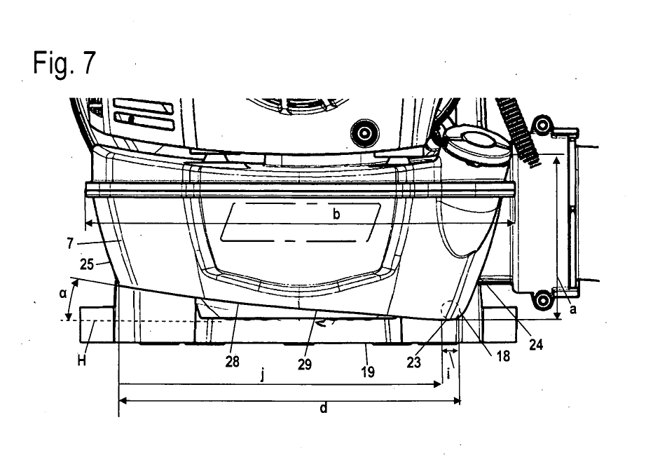

FIGS. 3 and 4 show the back carrier 2 carried by only one shoulder strap, namely with the right shoulder strap 3 in FIG. 3 and with the left shoulder strap 4 in FIG. 4. If the back carrier 2 is carried only with the right shoulder strap 3, the entire back carrier 2 in FIG. 3 tilts counter-clockwise, whereby the outer area of the second section 10 is inclined down and runs approximately horizontally. The first section 9, which is arranged underneath the right shoulder strap 3, is more inclined. The angle β is chosen such that the second section 10 is arranged approximately horizontally when the back carrier is carried by the right shoulder strap 3, so that the suction head 18, arranged in the middle section 11, is still supplied with fuel. Thereby, the bulk of the fuel in the fuel tank 7 can be drawn when the blower 1 is carried at an angle.

If, as shown in FIG. 4, the back carrier 2 is carried with the left shoulder strap 4, the first section 9 is arranged approximately horizontally, and the second section 10, arranged underneath the left shoulder strap 4, is more inclined. Here as well, the suction head 18 is still supplied with fuel even when the amount of fuel, which is needed for a minimum fill level, is increased relative to when the back carrier is carried horizontally (FIG. 2). As a result of the inclination of the tank base in sections 9 and 10, it is avoided that the suction head 18 is not supplied with a sufficient amount of fuel when only little fuel has been drawn. More specifically, the situation is prevented that the suction head comes to lie in an area of the fuel tank 8 in which there is no fuel or an insufficient fill level of fuel.

FIG. 5 shows the configuration of the fuel tank 7 in detail. The fuel tank 7 has a width (b) which is at least twice as large as the height (a) measured in the upward direction 21 (FIG. 2). The width (b) and the height (a) are thereby the entire width and the entire height of the fuel tank 7, respectively. The tank base 8 has a width (d). The first section 9 has a width (e) and the second section 10 has a width (f). The width (e) and the width (f) together extend over 70% of the width (d) of the tank base 8. Advantageously, the sections 9 and 10 extend over at least 90% of the width (d). The middle section 11 extends over a width (g) which is at most 30% of the width (d) of the tank base 8. Advantageously, the width (g) is less than 20%, especially less than 10%, of the width (d) of the tank base 8.

The first section 9 and the second section 10 decline toward the middle section 11. The first section 9 thereby borders laterally on a first side wall 24 of fuel tank 7 and the second section 10 borders laterally on a second side wall 25. The middle section 11 includes a lowest region 23 of the tank base 8, which is the lowest point of the fuel tank 7 when the base 19 of the back carrier 2 is arranged horizontally. The suction head 18 is arranged in the lowest region 23. The lowest area 23 is configured as small as possible and advantageously extends over less than 20% of the width (d) of the tank base 8. In the embodiment the width (i) of the lowest region 23 is about 3% of the width (d) of the tank base 8.

As FIG. 6 shows, the base 8 of the fuel tank 7 is noticeably inclined in its depth, that is, perpendicular to the upward direction 21 of the blower 1 and perpendicular to the width (d). The tank base 8 is in the middle section inclined at an angle (Y), which advantageously is at least 5°, relative to the horizontal line H. As FIG. 6 shows, the fuel tank 7 has an imaginary transverse plane 30, which divides the fuel tank 7 in its depth in the middle. The transverse plane 30 runs approximately parallel to the back carrier plate 15. The transverse plane 30 divides the fuel tank 7 into a section 31 facing the operator and a section 32 facing away from the operator. The section 32 projects outwardly in the embodiment. As FIG. 6 shows, the lowest region 23 is arranged in the front section 32 of the fuel tank 7 which faces away from the back carrier plate 15 and the operator 14.

All sections of the tank base 8 are downwardly inclined toward the lowest region 23 resulting in the tank base 8 having a funnel-like shape. In this way, a comparatively high fill level can be achieved in the fuel tank 7 with a very small amount of fuel. Accordingly, residual amounts of fuel in the fuel tank 7 can be easily drawn therefrom. The lowest region 23 is thereby advantageously configured as small as possible. However, the lowest region 23 is shaped such that the suction head 18 is accommodated in the lowest region 23.

FIG. 7 shows an embodiment for the configuration of the fuel tank 7. The same reference symbols identify the corresponding elements from the previous figures. The fuel tank 7 has a tank base 28 having a first inclined section 29. The section 29 extends from a side wall 25 of the fuel tank 7 over a large part of the width (d) of the tank base 28 up to the lowest region 23. The lowest region 23 borders on the opposite-lying wall 24 of the fuel tank 7. The section 29 is inclined thereby at an angle α, which is between about 7° and about 30° and advantageously between about 10° and about 20°, relative to the horizontal line H. The lowest region 23 has a width (i), which is advantageously less than 20% of the width (d) of the tank base 28. The section 29 has a width (j), which advantageously is at least 70% of the width (d) of the tank base 28, especially at least 90% of the width (d) of the tank base 28.

As FIG. 7 shows, the lowest region 23, in which the suction head 18 is also disposed, is arranged at the side of the fuel tank 7, which is arranged adjacent to the blower outlet of the blower and adjacent to the right arm of the operator 14. The lowest region 23 is thereby arranged on the side of the blower on which also the blower tube 12 is guided and on which the handle 13, with which the operator 14 guides the blower tube 12, is arranged. In the embodiment the operator guides the blower 1 with the right hand 26 (FIG. 1). If the back carrier 2 is carried with only one shoulder strap (3, 4), then the configuration shown in FIG. 4, in which the left shoulder strap 4 is arranged on the left shoulder of the operator 14 and the right shoulder strap 3 is not arranged on a shoulder, is typical. In this configuration the right side of the blower 1 and thus also the fuel tank 7 tilt downward. For this reason, the lowest region 23 should be arranged on this side of the blower 1, in this example the right side, when viewing the back of the operator 14.

It is understood that the foregoing description is that of the preferred embodiments of the invention and that various changes and modifications may be made thereto without departing from the spirit and scope of the invention as defined in the appended claims.

What is claimed is:

1. A back-carried work apparatus comprising:
a back carrier having two shoulder straps configured for carrying said back carrier on an operator's shoulders;
a drive motor configured as a combustion engine arranged on said back carrier;
a fuel tank for said combustion engine arranged on said back carrier, said fuel tank having a tank base;
said tank base having a width (d) and being configured to have a lowest region when said shoulder straps are arranged on the operator's shoulders; and,
said lowest region extending over less than about 20% of said width (d) of said tank base.

2. The back-carried work apparatus of claim 1, further comprising a fuel extraction device arranged in said lowest region.

3. The back-carried work apparatus of claim 1, wherein said tank base has a first section having an inclination which is inclined to the horizontal (H) when said shoulder straps are arranged on said operator's shoulders.

4. The back-carried work apparatus of claim 3, wherein said first section of said tank base is inclined at an angle (α) to said horizontal (H) and said angle (α) lies in a range between about 7° and about 30°.

5. The back-carried work apparatus of claim 3, wherein said tank base has a center; and, said first section is inclined downwardly toward said center.

6. The back-carried work apparatus of claim 3, wherein said tank base has a second section having an inclination; and, said second section is inversely inclined relative to said first section.

7. The back-carried work apparatus of claim 6, wherein said second section of said tank base is inclined at an angle (β) to said horizontal (H), and, said angle (β) lies in a range between about 7° and about 30°.

8. The back-carried work apparatus of claim 6, wherein said inclination of said first section of said tank base corresponds to said inclination of said second section of said tank base.

9. The back-carried work apparatus of claim 6, said tank base further comprising a middle section arranged between said first section and said second section; and, said middle section extends over less than about 30% of said width (d) of said tank base and includes said lowest region.

10. The back-carried work apparatus of claim 9, wherein said middle section of said tank base is rounded.

11. The back-carried work apparatus of claim 1, wherein said tank base is configured to be mirror-symmetrical to a center plane extending in the upward direction of said back carrier.

12. The back-carried work apparatus of claim 3, wherein said fuel tank has a first side wall and a second side wall; said first section is downwardly inclined from said first side wall toward said second side wall and said lowest region is arranged adjacent to said second side wall.

13. The back-carried work apparatus of claim 12, further comprising an operating handle by which said work apparatus can be guided during operation and said lowest region being arranged on the side of said fuel tank which faces toward said operating handle.

14. The back-carried work apparatus of claim 6, wherein said first section and said second section extend at least over about 70% of the width (d) of said tank base.

15. The back-carried work apparatus of claim 3, wherein said first section extends over at least 70% of the width (d) of said tank base.

16. The back-carried work apparatus of claim 1, wherein said fuel tank defines a center plane and said tank base has at least one region being downwardly inclined toward said center plane.

17. The back-carried work apparatus of claim 1, wherein said tank base has a funnel-like shape.

18. The back-carried work apparatus of claim 1, wherein said fuel tank has a transverse plane which divides said fuel tank at about the center into a first portion which faces toward said operator and a second portion which faces away from said operator; and, said lowest region is arranged in said second portion facing away from said operator.

19. The back-carried work apparatus of claim 1, wherein said fuel tank has a width (b), a depth (c) and a height (a) measured in the upward direction; said depth (c) is measured perpendicularly to said width (b) and said height (a); and, said width (b) is at least approximately twice said height (a) and is at least approximately twice said depth (c).

20. The back-carried work apparatus of claim 1, wherein said back carrier has a floor plate which extends in the direction of the horizontal (H) when said shoulder straps are arranged on said operator's shoulders.
